(19) United States
(12) Patent Application Publication
(10) Pub. No.: US 2018/0007910 A1
(43) Pub. Date: Jan. 11, 2018

(54) FUNGICIDAL COMPOSITION EFFECTIVE AGAINST ALTERNARIA ON CITRUS

(71) Applicant: ARYSTA LIFESCIENCE BENELUX SPRL, Ougree (BE)

(72) Inventor: Lara Ramaekers, Walshoutem (BE)

(21) Appl. No.: 15/544,471

(22) PCT Filed: Jan. 21, 2016
(86) PCT No.: PCT/EP2016/051206

§ 371 Date: Jul. 18, 2017

(30) Foreign Application Priority Data
Jan. 23, 2015 (BE) 201505036

(51) Int. Cl. A01N 47/44; A01N 25/04

(52) U.S. Cl. CPC A01N 47/44; A01N 25/04

(57) ABSTRACT

The current invention concerns a composition comprising an effective amount of a dodecylguanidine or salt thereof, preferably dodine, for use in the treatment of Alternaria on citrus. The invention also concerns a method of treating Alternaria on citrus by applying a composition comprising a dodecylguanidine or salt thereof, preferably dodine, in an effective dose and the use of a composition comprising an effective amount of a dodecylguanidine or salt thereof, preferably dodine, for the treatment of Alternaria on citrus.

### TECHNICAL FIELD

The invention pertains to the technical field of plant protection, in particular fungicides. More in particular it pertains to fungicides effective against Alternaria on citrus. The invention describes formulations of dodine, methods of treating Alternaria on citrus with dodine and the use of said dodine formulations as fungicide for the treatment of Alternaria on citrus.

### BACKGROUND

Leaf spot disease on citrus is one of the main diseases causing losses of yield and economic value in citrus cultivation. Leaf spot disease can be caused by different fungus species. Since 1994 the first signs of Alternaria alternata on a citrus plant appeared in Spain and in 1998 the first leaf spot disease caused by Alternaria alternata was reported in the region around Valentia. By 2005 the Alternaria alternata was reported over 80 times in Spain and had spread to 7 provinces. Worldwide the disease has spread to all the major citrus producing countries.

Most countries, including Spain, only allow the use of copper based fungicides and mancozeb in the treatment of leaf spot disease on citrus. These fungicides only have a preventive activity. The short incubation time of the disease results in numerous applications of these fungicides to prevent the disease from spreading. Numerous applications cause a build-up of copper in the soil and the limitations used in organic farming, EC/473/2002 regulation by the European Union, are reached fairly soon, leaving the crop unprotected to Alternaria alternata infection. The authorization of mancozeb is currently under review in some countries. The future of this fungicide is unclear as its main metabolite ethyleenthioureum (ETU) is possibly carcinogenic.

In an attempt to reduce the number of treatments needed, a warning system is set up that registers the weather conditions and when the weather conditions are in favour for Alternaria alternata citri to grow, a warning is send out with the instruction to apply the fungicide. But even with this system in place the build-up of copper compounds in the soil reaches the limits over the years as crop rotation in citrus plantation is very slow due to the average lifespan of the citrus trees.

There is an urgent need for a fungicide that can prevent leaf spot disease on citrus. There is an interest to avoid build-up of copper in soil. It would be beneficial to find a fungicide that can be applied and is effective after infection of Alternaria alternata has been recorded.

The present invention thereto aims to provide an alternative fungicidal composition for use in the treatment of Alternaria on citrus. In addition it aims to provide a method which overcomes at least one of the problems mentioned above.

### SUMMARY OF THE INVENTION

In a first aspect the invention provides a composition for use in the treatment of Alternaria alternata, on a citrus plant. The composition comprises a dodecylguanidine or salt thereof, preferably dodine, as active ingredient in a concentration effective against Alternaria on citrus.

Dodine has been proven effective in the treatment of Alternaria on citrus. It is advantageous that a well-known molecule, is found effective. Dodine is regarded to have no long term adverse effects.

In a second aspect the invention provides a method for treating Alternaria, preferably Alternaria alternata, on citrus and/or on citrus trees, wherein a dodecylguanidine or salt thereof, preferably dodine, is applied on leaves, fruits, blossom or a combination of previous.

A method comprising the application of dodine as a fungicide can be regarded as a valuable alternative to known treatments. It provides farmers with more possibilities to control a deleterious disease on citrus fruits. Dodine treatments are without a build-up of copper compounds in the soil. There is no formation of ETU, hence concerns regarding its toxicology profile are avoided.

In a third aspect the invention provides in a use of a composition comprising a dodecylguanidine or salt thereof, preferably dodine, as fungicide against Alternaria, preferably Alternaria alternata, on citrus.

### FIGURES

FIG. 1 is a graphic representation of the weather conditions at the site of the orange plantation.

FIG. 2 is a boxplot of the first analysis of leaf spot disease on the sprouts of mandarin trees, treated with or without dodine.

FIG. 3 is a boxplot of the weight of fruits produced for each tree.

FIG. 4 is a boxplot of the percentage of fruits classified in the Extra Class for each tree.

FIG. 5 is a boxplot of the percentage of fruits classified in the Extra Class and the Class 1 for each tree.

FIG. 6 is a boxplot of the percentage of fruits classified as marketable, the Extra Class, Class 1 and Class 2, for each tree.

FIG. 7 is a boxplot of the percentage of fruits classified as Out of grade, for each tree.

FIG. 8 is a graphical presentation of the dodine concentration dependence of the growth inhibition of Alternaria alternata on citrus.

FIG. 9 is a graphical presentation of the percentage of fruits in the category Extra (Y-axis) from a 2014 field trial with Syllit SC (dodine 544 g/l). Presented in the X-axis are the results from the spring treatment with Syllit (A), autumn treatment with Syllit (B), combination of results from spring and autumn treatment with Syllit (C) and the control group with no treatment (D).

### DETAILED DESCRIPTION OF THE INVENTION

“About” as used herein referring to a measurable value such as a parameter, an amount, a temporal duration, and the like, is meant to encompass variations of 35+/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

The recitation of numerical ranges by endpoints includes all numbers and fractions subsumed within that range, as well as the recited endpoints.

The expression “% by weight” or “wt %” (weight percent), here and throughout the description unless otherwise defined, refers to the relative weight of the respective component based on the overall weight of the formulation.

The present invention is based on the finding that dodine can effectively control brown spot disease on citrus plants, especially on citrus and tangerine.

The causal agent of brown spot disease on citrus plant is Alternaria. The term “Alternaria” as used herein refers to a genus of Ascomycota fungi that can be divided in a large number of species. Alternaria citri, alternatively named Alternaria alternata, is a species growing on lemons, oranges and other citrus fruits.

The term “citrus” as used herein refers to “a citrus plant”, i.e. fruit or tree of the genus Citrus, preferably selected from the list of citrus, mandarine, clementine, tangerine, orange, kumquat, lemon, lime, grapefruit, pomelo, citrange, citron.

Alternaria species are known as major plant pathogens. Some strains of Alternaria alternata (Fr.) Keissl. are known to produce host-selective toxins (HST) that are selectively toxic to certain plants. This selectivity correlates to the pathogenicity reactions of the fungi that produce them. Therefor to distinguish further, pathotypes are defined.

On citrus plants, two pathotypes can be distinguished, in particular A. alternata lemon pathotype and A. alternata tangerine pathotype. The lemon pathotype is the causal agent of brown leaf spots on young leaves of lemon and lime. The A. alternata tangerine pathotype causes brown leaf spots on young leaves of tangerine and mandarin.

Citrus varieties susceptible to the disease include Fortune, Mineola and Nova.

In a first aspect the invention provides in dodine as fungicidal active ingredient against Alternaria alternata (Fr.) Keissl. on citrus, preferably Alternaria alternata tangerine pathotype.

The invention thereto provides an agrochemical composition comprising an effective amount of a dodecylguanidine or salt thereof, preferably dodine, as active ingredient for use in the treatment of Alternaria on a citrus plant.

A preferred embodiment of a dodecylguanidine salt is dodine. Dodine or 1-dodecylguanidiniumethanoate is a salt of n-dodecylguanidine and acetic acid. It has the chemical structure shown below by formula I and has CAS 2439-10-3 assigned to this molecule.

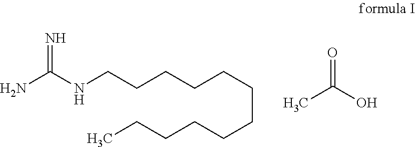

Alternatively, the acid can be a monocarboxylic acid such as propionic, capric, stearic, benzoic, or naphtoic acid; or a dicarboxylic acid such as malonic or succinic acid; or a mineral acid such as hydrochloric, sulphuric, bisulphuric or nitric acid.

In a preferred embodiment, dodine is the only antifungal active ingredient in the composition. In a preferred embodiment, dodine is the only antifungal active ingredient in the composition. Dodine is regarded as a slightly hazardous compound by the world health organisation (WHO) classification III. A combination with another anti-fungal active ingredient could cause a different, less favourable, classification.

In a preferred embodiment, the composition does not contain any compounds containing copper, copper ions or metallic copper. The use of a copper-free composition has the advantage that no copper compounds build up in the soil and that the copper content of the soil stays under the limitations of organic agriculture defines by the European Union in EC/473/2002 regulation.

In preferred embodiment, the composition is a wettable powder. A wettable powder has the advantage that no water or solvent needs to be shipped or stored, suppressing the cost of transport and storage. The chemical stability of the active ingredient can be prolonged in a dry environment.

In preferred embodiment, the composition is in the form of water dispersible granules (WG or WDG). Water dispersible granule formulations have the advantage that no water or solvent needs to be shipped or stored, suppressing the cost of transport and storage. The chemical stability of the active ingredient can be prolonged in a dry environment. When handling wettable granules, no or very little dust is generated in comparison to handling a powder. Handling granules versus a powder reduces inhalation toxicity. When handling a wettable powder extra precaution needs to be taken to prohibit the inhalation of the dust. When finishing a package of wettable granules, less active ingredient remains in the packaging material than when finishing a package of wettable powder, having an economical and an ecological advantage.

In another preferred embodiment, the composition is a suspension concentrate (SC) of dodine. Preferably the SC formulation comprises water as solvent. The concentrate can be diluted to the desired concentration needed for the treatment of the disease, and the handling of a liquid doesn't generate the same level of exposure to dodine for the person handling the composition, as when handling a powder. Obtaining a correct concentration starting from a liquid concentrate is easier than using a powder to obtain a correct concentration. Liquids can be measured out by their volume, as for solids and especially powder, large variations are made when using a volume of a solid due to different compression of the solid. To obtain a correct concentration using a solid, scales need to be used instead of a simple measuring cup when using a liquid.

In another preferred embodiment, a composition according to the invention comprises as active ingredient dodine and an inert support material. In a preferred embodiment said support material is pulverulent solid material and the composition is a mixture of the active ingredient in powder form and the support material. In a more preferred embodiment, a composition for use in the invention is a flow (FL) formulation of dodine.

In a preferred embodiment, the fraction of active ingredient, preferably dodine, in a suspension concentrate of the invention is preferably 40%-80% by weight, in particular 45%-60% by weight, more preferably 50%-55% by weight, expressed versus the total weight of the composition.

In a preferred embodiment, the fraction of water in a suspension concentrate of the invention is 20%-60% by weight, preferably 30%-45% by weight, more preferably 35%-40% by weight, expressed versus the total weight of the composition.

In a preferred embodiment of the invention, the active ingredient, preferably dodine, is present with a minimum content of 400 g of active ingredient/l, preferably 440-820 g of active ingredient/l, more preferably 544 g/l or 600 g/l of active ingredient/l of the overall formulation, most preferably 544 g/l.

Particle size is typically defined as a log-normal distribution with a median diameter or d₅₀—that is 50% of the particles measured are less than the median value and 50% are greater than the median value. The term “particle size distribution” as used herein refers to the relative percentages by weight or volume of each of the different size fractions of a particulate matter. The term “median particle size”, “median diameter of particles”, “d₅₀”, as used herein refers to the median or 50% quantile of a particle size distribution. The term “d₅₀” hence defines a size where 50 volume percent of the particles have sizes less than the value given.

In spite of the large particle size, suspension concentrate formulations with a median particle diameter of 7 μm to 20 μm had a viscosity below 1500 cPS. This is workable and allows the preparation of formulations with relatively high concentration.

In a preferred embodiment, d₅₀ is below 20 μm. Preferably d₅₀ is between 7-20 μm, more preferably D₅₀ is 8-15 μm, most preferably d₅₀ is 9-10 μm. Within this range the SC-formulation, even if highly concentrated, remains stable upon prolonged storage.

A suspension concentrate of the invention is preferably characterized in that 50% of the particles of the overall formulation, preferably 50% of the particles of the active ingredients (component a), have a size of at least 7 μm (d50>=7 μm).

More preferably 60%, even more preferably 80%, most preferably more than 90%, of the a.i. particles of the overall suspension concentrate have a size of at least 7 μm.

In a preferred embodiment at most 2% of the a.i. particles have a particle size of at least 75 μm (d₉₈).

The particle size distributions for formulations can be measured using laser light diffraction equipment, such as are sold by Malvern Instruments Ltd., Malvern, Worcestershire, United Kingdom.

It is additionally possible to add further formulation auxiliaries to these formulations of a dodecylguanidine or salt thereof (a), such as anti-freeze compounds (b), wetting agents (c1), dispersing agents (c2), antifoaming agents (d), preservatives (e), or dyes (f).

These formulation auxiliaries are described for example in Chemistry and Technology of Agrochemical Formulations, ed. D. A. Knowles, Kluwer Academic Publishers (1998) and Controlled-Release Delivery Systems for Pesticides Herbert B. Scher, Marcel Dekker, Inc. (1999).

The fraction of these formulation auxiliaries in a suspension concentrate of the invention is preferably 1%-30% by weight, in particular 2%-15% by weight, more preferably 5%-10% by weight, expressed versus the total weight of the composition.

In a preferred embodiment of the invention, the anti-freeze compound (component b) is selected from the list of glycols, glycerols, urea and mixtures thereof.

In a preferred embodiment, the anti-freeze compound (component b) is a glycol selected from the list of ethylene glycol, diethylene glycol, triethylene glycol, propylene glycol, dipropylene glycol, tripropyleneglycol, glycerol, and mixtures thereof.

In a particularly preferred embodiment, the anti-freeze compound is propylene glycol.

The term “surfactant”—which includes the terms “emulsifier” and “detergent”—as used herein means a composition of matter that either alters surface tension when dissolved in water or an aqueous solution, or alters interfacial tension between immiscible liquids or a liquid and a solid.

Surfactants (c) suitable for purposes of the present invention are listed in McCutcheon's Emulsifiers & Detergents, at pages 287-310 of the North American Edition (1994), and in McCutcheon's Emulsifiers & Detergents, at pages 257-278 and 280 of the International Edition (1994), both published by MC Publishing Co. (McCutcheon Division) of Glen Rock, N.J.

In this regard, suitable surfactants include, but are not limited to, alkylamine ethoxylates, acrylate graft copolymer ethoxylates, block polymers, carboxylated alcohol or alkylphenol ethoxylates, alcohol ethoxylates, ethoxylated alkylphenols, glycol esters, polyethylene glycols, silicone-based surfactants, and tristyrylphenol ethoxylates.

In a preferred embodiment, the surfactant is an acrylate graft copolymer. An example of a suitable surfactant (c) for use formulations according to the present invention is an acrylate graft copolymer, e.g. commercially available under the name Tersperse 2500 (Huntsman). This surfactant is easily soluble in water and acts as a dispersant.

Preferred surfactants are selected from the group consisting of wetting agents, dispersing agents and mixtures thereof.

In a preferred embodiment the wetting/dispersing agent is not an anionic wetting or dispersing agent. Incompatibility with dodine is thereby avoided. In a more preferred embodiment, the dispersing/wetting agent is non-ionic.

Wetting agents serve to reduce the surface tension at the water-solid interface and therefore increase the tendency of the water to contact the complete surface of the active ingredient particles.

In a preferred embodiment of the invention, the wetting agent (component c1) is an ethoxylate. In a particularly preferred embodiment of the invention, the wetting agent (component c1) is selected from the list of alkylamine ethoxylates, alkylphenol ethoxylates, alcohol ethoxylates, and tristyrylphenol ethoxylates.

In a preferred embodiment the wetting agent (component c1) is an alkylamine ethoxylate. Examples of alkylamine ethoxylate wetting agents (component c) suitable for use in the present invention are Rhodameen RAM 7 (Rhodia) or Emulson AG/NHT (Cesalpina). The advantage of this surfactant is that it acts as an emulsifier and shows a high degree of compatibility with dodine.

In another preferred embodiment the wetting agent (component c1) is an alcohol ethoxylate. Alcohol ethoxylates are prepared from saturated or unsaturated, linear or branched aliphatic alcohols having on average from 8 to 20 carbon atoms, and which contain from 5 to 25, typically from 10 to 20, ethylene oxide units per molecule. Preferred are alcohol ethoxylates which contain from 12 to 18 carbon atoms in the alcohol moiety and 10 to 20 ethylene oxide units.

Examples of alcohol ethoxylates are Brij, Volpo, Arlasolve, Atphos, Synperonic and Lubrol, Synperonic 91-6, Atplus MBA 11-7 (Uniqema).

Examples of tristyrylphenol ethoxylate wetting agents (component c1) are Soprophor® 3D33 (=tristyrylphenol ethoxylated with 16 EO and phosphated), Soprophor® BSU (=tristyrylphenol ethoxylated with 16 EO), Soprophor® CY/8 (Rhodia) (=tristyrylphenol ethoxylated with 20 EO), and Hoe® 53474 (=tristyrylphenol ethoxylated with 20 EO) and in the form of the Sapogenat® T product (Clariant), such as Sapogenate T 100 (=triisobutylphenol ethoxylated with 10 EO), for example.

The fraction of surfactants in a suspension concentrate of the invention is preferably 0.5%-10% by weight, preferably 1%-5% by weight, more preferably 2%-4% by weight, most preferably around 3% by weight.

In a preferred embodiment of the invention, the weight ratio of wetting agent to a dodecylguanidine or salt thereof, preferably dodine, is between 1/8 to 1/80, preferably between 1/10 to 1/25, more preferably between 0.04-0.06.

The term “dispersant” or “dispersing agent” (c2) as used herein connotes a surface-active agent that is added to suspending media to promote uniform suspension or separation of solid particles, often of micrometre size.

Dispersants (components c2) are listed in McCutcheon's Functional Materials, at pages 122-142 of the North American Edition (1994), as well as in McCutcheon's Functional Materials, at pages 47-56 of the International Edition (1994), both published by MC Publishing Company (McCutcheon Division) of Glen Rock, N.J.

In this regard, suitable dispersants for use in the present invention include, but are not limited to, acrylate graft copolymers. Examples of acrylate graft copolymer dispersing agents (component c2) are commercially available as Tersperse 2500 (Huntsman).

In a preferred embodiment of a composition according to the invention, the wetting agent and/or the dispersing agent are an ethoxylated alkylamine and/or an acrylate graft polymer, preferably a combination of these two ingredients.

The term “antifoaming agent” or “foam-control” agent (d) or ingredient shall be understood to mean a substance that is used to reduce foaming. Foaming may result from the presence of foam-inducing agents as proteins, gases, or nitrogenous materials. The presence of foam is generally undesirable because foam may interfere with processing, e.g. application by spraying.

Antifoaming agents are generally discussed at pages 430-447 in the Kirk-Othmer Encyclopaedia of Chemical Technology, third edition, volume 7, published 1979 by John Wiley & Sons, Inc.

Suitable antifoaming agents (component d) for purposes of the present invention include but are not limited to silicone-based defoamers, from Wacker, Rhodia or Dow Corning, for example; acetylene-based defoamers, such as those from Air Products, for example, and perfluoroalkylphosphinic acid and phosphonic acids and their salts.

Preferred defoamers are those from the group of linear polydimethylsiloxanes having an average dynamic viscosity, measured at 25° C., in the range from 1000 to 800 mPa·s, usually 1200 to 6000 mPa·s, and containing silica. Silica includes polysilicic acids, meta-silicic acid, ortho-silicic acid, silica gel, silicic acid gels, kieselguhr, precipitated SiO2, and the like.

Defoamers from the group of linear polydimethylsiloxanes contain as their chemical backbone a compound of the formula HO—[Si(CH3)2-O-]n-H, in which the end groups are modified, by etherification for example, or are attached to the groups —Si(CH3)3. Examples of defoamers of this kind are Rhodorsil® Antifoam 416. Other suitable defoamers are Rhodorsil® 1824, Antimussol 4459-2 (Clariant, Defoamer V4459 (Clariant), SE Visk and AS EM SE 39 (Wacker).

Particularly preferred are polydimethylsiloxane, wherein two methyl groups are attached to each silicon atom to form (H₃C)[SiO(CH₃)₂]ₙSi(CH₃) and simethicone, which is a mixture of polydimethylsiloxane and silica.

An example of a suitable defoamer for use in a composition of the present invention is commercially available as Rhodorsil® 481 and Rhodorsil® 454 (polydimethylsiloxane and silicon) from Rhodia.

An aqueous suspension concentrate according to an embodiment of the invention may further comprise e) a thickening agent and/or f) a preservative.

A suitable thickening agent (component e) for use in the present invention is a hydroxyethylcellulose, a gelling and thickening agent derived from cellulose. Especially preferred is hydroxyethylcellulose surface-treated with glyoxal.

Suitable preservatives (component f) are biocidal compounds, an example being 1,2-Benzisothiazolin-3-one, and MBS (mixture of 1,2-benzoisothiazol-3(2H)-one and 2-methyl-2H-isothiazol-3-one, biocide.

In a preferred embodiment of the invention, the suspension concentrate further comprises e) a thickening agent and/or f) a biocidal compound in a concentration of up to 1%, expressed by weight based on the total weight of the composition.

In a preferred embodiment, the composition comprises:
a) 40 to 80% a dodecylguanidine or salt thereof, preferably dodine
c) 1 to 10% wetting agent and/or dispersing agent,
g) remainder water;
all percentage are expressed by weight based on the total weight of the composition.

In a preferred embodiment, the composition also comprises up to 10% of an anti-freeze compound.

In a preferred embodiment of the invention, the suspension concentrate comprises, expressed by weight based on the total weight of the composition:
a) 45 to 60% a dodecylguanidine or salt thereof, preferably dodine;
b) 1 to 5% anti-freeze compound,
c) 1 to 5% wetting agent and up to 2% of a dispersing agent
d) up to 2% antifoaming agent, and
g) remainder water.

In a preferred embodiment, a composition according to the invention further comprises an anti-foaming agent and/or a thickening agent.

In a preferred embodiment of the invention, the suspension concentrate comprises, expressed by weight based on the total weight of the composition:
a) 50 to 55% a dodecylguanidine or salt thereof, preferably dodine;
b) 3% anti-freeze compound,
c) 3% wetting agent and 1% dispersing agent,
d) 1% antifoaming agent,
e) 0.1% thickener,
f) 0.1% preservative, and
g) remainder water.

With a suspension concentrate comprising dodine of an average particle size between 7 and 20 μm it is generally possible to achieve an equal or better biological effect for the same application rate compared to dodine of a classical average particle size below 5 μm. Due to the larger particle size versus conventional formulations, the formulation is less toxic by inhalation to humans.

A highly-concentrated suspension concentrate of the invention permits the associated advantages, such as a lower level of packaging, as a result of which the cost and complexity involved in producing, transporting, and storing is simplified and the preparation of spray liquors used in agriculture can be managed more effectively as a result of the smaller quantities, such as in the context of dispensing operations and stir-mixing operations, for example.

Use of a highly loaded dodine suspension concentrate in the invention allows to save on transportation costs. This contributes to the overall objective of ecological farming.

Additionally the suspension concentrates described produce formulations which are stable on storage for long periods.

The invention further provides compositions obtainable from the suspension concentrate of the invention by dilution with liquids, preferably aqueous liquids, more preferably water.

In a second aspect the invention provides in a method of treating Alternaria alternata, on citrus and/or on citrus trees.

In a preferred embodiment, a dodecylguanidine or salt thereof, preferably dodine; is applied in an effective dose between 300 g and 3000 g per hectare, more preferably between 500 and 2000 g per hectare, even more preferably between 600 and 1500 g per hectare and most preferably between 680 g and 1200 g per hectare.

In another preferred embodiment, a dodecylguanidine or salt thereof, preferably dodine; is applied in an effective concentration between 0.2 g/l and 10 g/l, preferably between 0.5 g/l and 7 g/l, more preferably between 0.7 g/l and 5 g/l, even more preferably between 1 g/l and 3 g/l and most preferably between 1.3 g/l and 2 g/l.

An effective concentration is applied on a tree in an amount between 1 liter/tree and 15 liter/tree, preferably between 2 liter/tree and 13 liter/tree, more preferably between 3 liter/tree and 10 liter/tree, even more preferably between 4.5 liter/tree and 7 liter/tree and most preferably between 5 liter/tree and 6 liter/tree.

In yet another preferred embodiment, between 0.5 g and 15 g of a dodecylguanidine or salt thereof, preferably dodine; is applied on one tree at each application, preferably between 1 g and 10 g, more preferably between 2.5 g and 7.5 g, even more preferably between 4 g and 6 g and most preferably 5 g for each tree.

The method of applying of the present composition is preferably by foliage spraying. It is usually applied after diluting with water.

In a preferred embodiment, the suspension is applied preferably 2 weeks, more preferably 1 week, even more preferably 4 days and most preferably 2 days before or after rainy periods. These rainy periods are usually more abundant in spring or autumn.

In a preferred embodiment, applications can be done on growing or mature fruit to protect the esthetics of the peel.

In a preferred embodiment, the suspension is applied preferably once every month, more preferably once every 3 weeks and most preferably once every 2 weeks. Dodine was found to have a preventative, curative and eradicant effect on Alternaria on citrus and/or citrus trees.

The treatment may be curative or preventive.

In another preferred embodiment, application of a composition comprising dodine is combined with the use of a warning system for the occurrence of conditions that favor Alternaria on citrus. The warning system may take into account weather conditions, preferably temperature and/or rainfall. In a further preferred embodiment, the warning system generates a suggestion for fungal application when:
the average day temperature in the last period of time, preferably 5, 7, 10 or 14 days is higher than a certain value, preferably 10° C., more preferable more than 12.5° C.; and/or,
the amount of rainfall in said last period of time is higher than 1 mm, preferably higher than 2 mm, most preferably 2.5 mm.

The combination of dodine applications with a warning system allows to keep the number of sprays to a minimum. It allows for optimal product application.

In a preferred embodiment of a method according to the invention, a composition comprising a dodecylguanidine or salt thereof, preferably dodine, is applied within four days, preferably within three days, more preferably within two days and most preferably within one day of an Alternaria-warning on citrus.

Alternatively, the treatment may comprise a further active ingredient. The present composition can be used with one or more fungicides, insecticides, miticides, nematicides, herbicides, plant growth regulating agents, fertilizers or soil improvers. The active ingredients can be applied simultaneously or consecutively.

In a third aspect the invention provides in a use of a composition comprising a dodecylguanidine or salt thereof, preferably dodine, as fungicide against Alternaria and preferably Alternaria alternata. This disease is devastating to citrus trees. Availability of an alternative fungicide, approved under the European Plant Protection Directive (EC 91/414) is highly desirable and economically relevant.

In a preferred embodiment, a composition comprising a dodecylguanidine or salt thereof, preferably dodine, is used as a fungicide for the treatment of Alternaria on citrus trees.

Most preferably, a dodecylguanidine or salt thereof, preferably dodine, is used for the control of Alternaria alternata tangerine pathotype or Alternaria alternata lemon pathotype.

In a preferred embodiment, a composition comprising a dodecylguanidine or salt thereof, preferably dodine is used as a fungicide for the treatment of Alternaria on citrus trees to increase the quality of citrus fruit compared to untreated fruit as measured according to the international quality standard for citrus established by the Organisation for Economic Co-operation and Development (OECD) in 2010.

In a preferred embodiment, a composition according to the first aspect of the invention is used, in a method according to the second aspect of the invention.

The present invention will be now described in more details, referring to examples that are not limitative.

### EXAMPLES

### Example 1: Wettable Powder Comprising Dodine (Dodine 65 WP)

In a first example, a composition comprising dodine is provided in the form of a wettable powder, as displayed in Table 1.

TABLE 1
wettable powder (dodine 65 WP)

| Composition | Amount (% w/w) |
|---|---|
| Dodine | 65 |
| Aluminium silicate hydrate | 10-30 |
| Sodium di-hexyl sulphosuccinate | 1-5 |
| Silica | >1 |

### Example 2: Suspension Concentrate Comprising Dodine (Dodine 544 SC)

In a second example a composition comprising dodine is provided in the form of a suspension concentrate, as displayed in Table 2.

TABLE 2
suspension concentrate comprising dodine (dodine 544 SC)

| Composition | Amount (g/l at 20° C.) |
|---|---|
| Dodine (expressed as 100% active) | 544 |
| Wetting agent/dispersing agent | 40 |
| Propylene glycol | 30 |
| Water | Remainder |

### Example 3: Method for Treating and Preventing Alternaria alternata on a Citrus Plant Using Dodine

The following method of combatting Alternaria alternata on a citrus plant was tested. On a plot of mandarin trees of the variety “Nova” in the province of Valentia (Spain) that was strongly affected by citrus leaf spot disease a trial with dodine was carried out. The test group and the group treated with the composition comprising dodine consisted of 14 trees each randomly chosen over the plot.

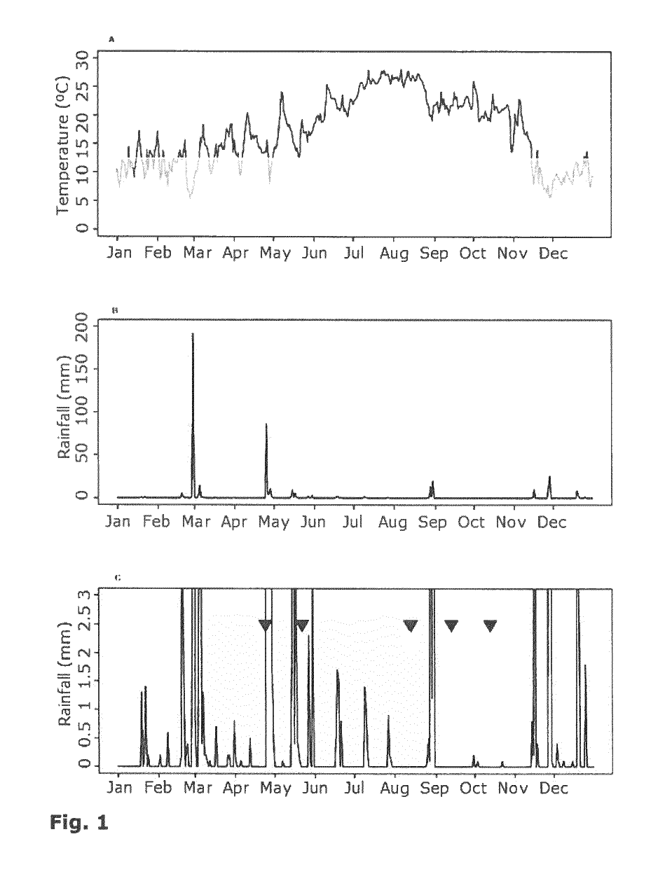

Application of the composition comprising dodine was based on information from the warning system. This system assumes that Alternaria alternata is always present and that Alternaria alternata grows strongly at certain weather conditions. Application was done on days when the average day temperature were higher than 12.5° C. for longer than one week in a row and when the total amount of rainfall in that week was higher than 2.5 mm. Based on these criteria 5 application dates were generated during the growing season: 13 April, 22 May, 27 Augustus, 26 September and 29 October. See FIG. 1 for temperature and rainfall data.

FIG. 1 represents the weather conditions at the site of the orange plantation. FIG. 1A depicts the average day temperature (Y-axis) over the year (X-axis), an average day temperature above 12.5° C. (dark grey) is assumed to be in favour for Alternaria alternata to grow. FIG. 1B depicts the daily rainfall (Y-axis) over the year (X-axis) and FIG. 1C is a zoom in of FIG. 1B. The 5 triangles on this graph are the moments of application of the composition comprising dodine.

Each application was done with a composition comprising dodine according to example 2. 200 ml of this suspension concentrate was diluted in 100 l water and from this dilution 4.5 l was applied on each tree.

Harvest of the mandarins was done on 12 December and 100 fruits were selected at random from each tree and analysed according to the international quality standard for citrus established by the Organisation for Economic Co-operation and Development (OECD) in 2010, dividing the citrus fruits into 4 classes based on the damage done by fungal infection. The four classes are: Extra Class, Class 1, Class 2 and out of grade. The results were then statistically analysed and differences in populations were determined via a Student's t-test. The results are discussed in the examples that follow.

### Example 4: Sprouts Affected by Alternaria alternata

This example is a continuation of the example given in Example 3.

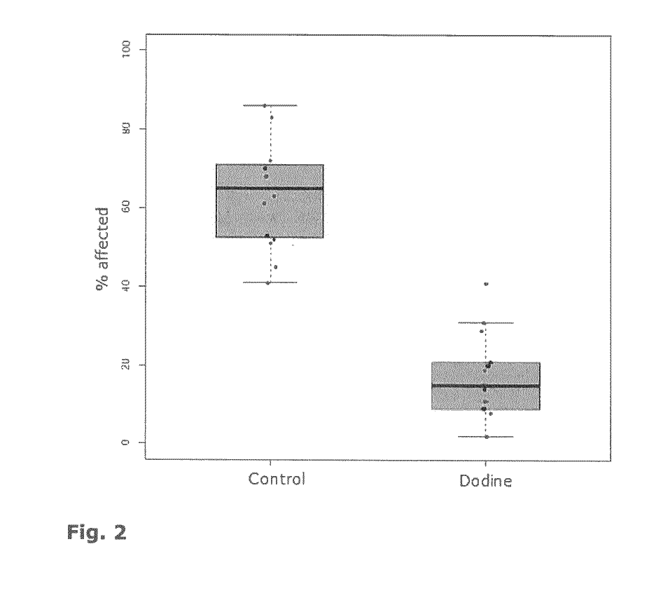

On 22 May, the day of the second application of the composition comprising dodine an analysis was made on the presence of leaf spot disease on the sprouting mandarin trees. For each tree the percentage of sprouts affected by the disease was obtained and is represented in a box plot in FIG. 2.

FIG. 2 is a boxplot of the first analysis of leaf spot disease on the sprouts of the mandarin trees. The fat line in the box represents the mean value of sprouts being affected by Alternaria alternata, the bottom line represents the 25% barrier, meaning that 25% of the trees has less sprouts affected by Alternaria alternata than this value. The top line of the box represents the 75 barrier, meaning that 75% of the trees have less than this value affected sprouts, the whiskers on the box represent the maximum and the minimum value of sprouts affected by Alternaria alternata bearing in mind that extreme values are not taking in account. Out of a Student's t-test follows that the treated and the untreated population are different with a 99.9% probability.

For trees treated with the composition comprising dodine on average 23.16% of the sprouts were affected compared to the untreated control group where on average 59.58% form the sprouts were affected. These 2 populations were significantly different from each other as the P-value was smaller than 0.01.

### Example 5: Weight of Fruits for Each Tree

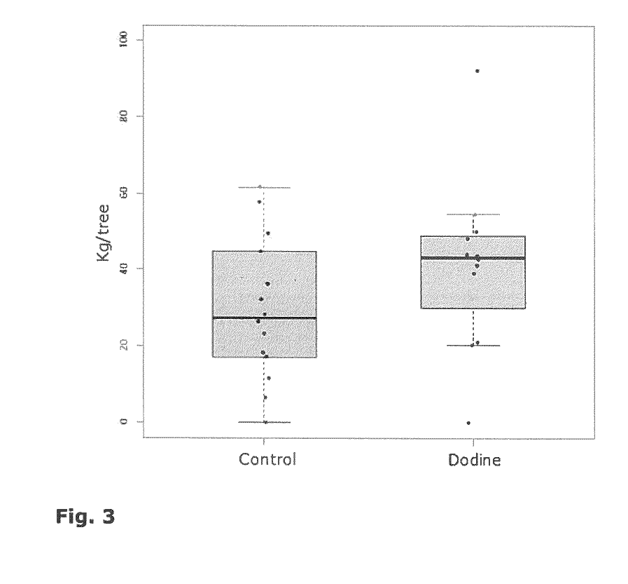

This example is a continuation of the example given in Example 3. On 12 December, the mandarins were harvested and the weight of the fruits for each tree was calculated. The results are represented in a boxplot in FIG. 3.

FIG. 3 is a boxplot of the weight of fruits produced by each tree for the untreated group and the group that was treated with a composition comprising dodine. Each boxplot represents the mean value, the fat line in the box; the 25% barrier, the bottom line of the box; the 75% barrier, the top line of the box and the maximum and minimum values without the extreme values represented by the whiskers.

The average weight per tree for the group treated with a composition comprising dodine was 41.41 kg/tree. The average weight per tree for the control group was 28.59 kg/tree.

### Example 6: Classification of Fruits

This example is a continuation of the example given in Example 3.

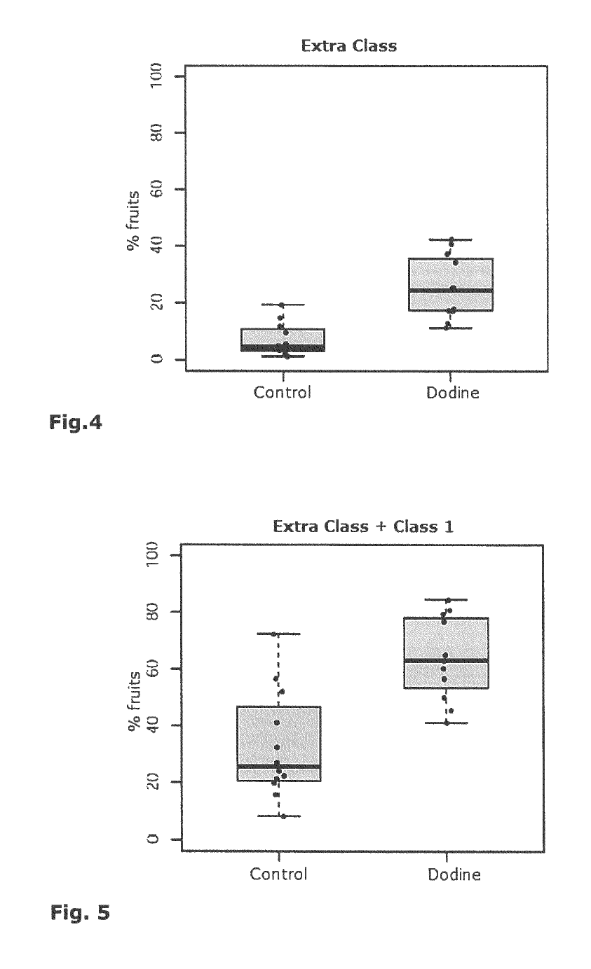

After harvest, 100 fruits from each tree were randomly selected and these selected fruits were divided into the 4 different classes defined by the international quality standard for citrus by the Organisation for Economic Co-operation and Development (OECD) in 2010, see FIG. 2, based on the damage caused by Alternaria alternata. The results are represented in FIG. 4-7.

FIG. 4 is a boxplot of the percentage of fruits classified in the Extra Class for each tree for the untreated group and for the group that was treated with a composition comprising dodine. Each boxplot represents the mean value, the fat line in the box; the 25% barrier, the bottom line of the box; the 75% barrier, the top line of the box and the maximum and minimum values without the extreme values represented by the whiskers. The 2 populations are significantly different from each other, P-value smaller than 0.01.

On average 25.58% of the fruits were classified in the Extra Class for the trees treated with a composition comprising dodine compared to on average 6.83% of the fruits produced by the trees in the untreated control group. Out of the Student's t-test on these data results that the 2 populations were different with a 99.9% probability, P-value was smaller than 0.01.

The average percentage of fruits for each tree out of the group that was treated with a composition comprising dodine, classified in the Extra Class or the Class 1 was 63.93% compared to 32.73% of the fruits produced by untreated trees from the control group, see FIG. 5.

FIG. 5 is a boxplot of the percentage of fruits classified in the Extra Class and the Class 1 for each tree for the untreated group and for the group that was treated with a composition comprising dodine. Each boxplot represents the mean value, the fat line in the box; the 25% barrier, the bottom line of the box; the 75% barrier, the top line of the box and the maximum and minimum values without the extreme values represented by the whiskers. The 2 populations are significantly different from each other, P-value smaller than 0.01.

Out of the Student's t-test on these data results that the 2 populations are different with a 99.9% probability, P-value was smaller than 0.01.

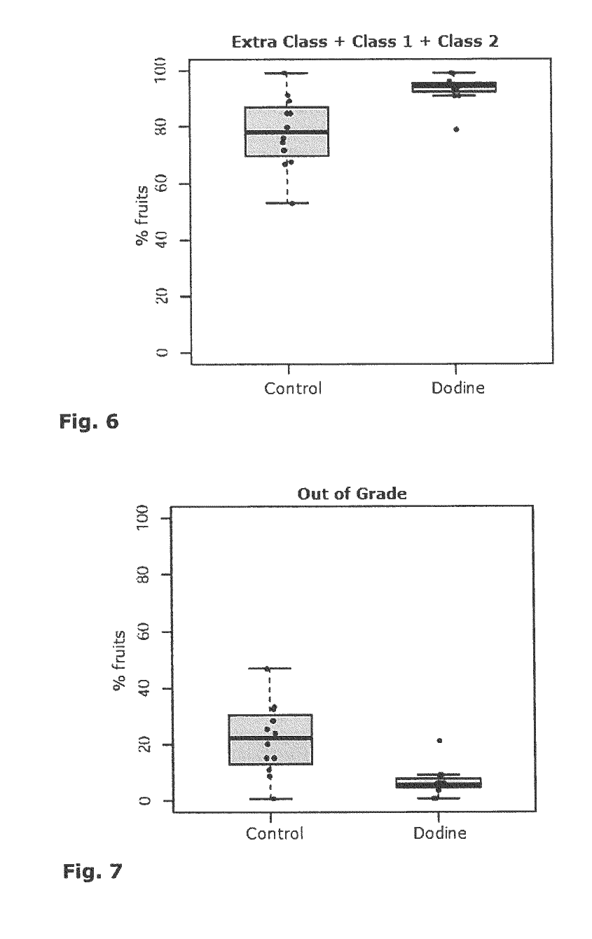

The average percentage of fruits for each tree out of the group that was treated with a composition comprising dodine, classified as marketable fruits, comprising the Extra Class, the Class 1 and Class 2, was 93.31% compared to 78.18% of the fruits produced by untreated trees from the control group, see FIG. 6.

FIG. 6 is a boxplot of the percentage of fruits classified as marketable, the Extra Class, Class 1 and Class 2, for each tree for the untreated group and for the group that was treated with a composition comprising dodine. Each boxplot represents the mean value, the fat line in the box; the 25% barrier, the bottom line of the box; the 75% barrier, the top line of the box and the maximum and minimum values without the extreme values represented by the whiskers. The 2 populations are significantly different from each other, P-value smaller than 0.01.

Out of the Student's t-test on these data results that the 2 populations were different with a 99.9% probability, P-value was smaller than 0.01.

The average percentage of fruits for each tree out of the group that was treated with a composition comprising dodine, classified as Out of grade was 6.68% compared to 21.81% of the fruits produced by untreated trees from the control group, see FIG. 7.

FIG. 7 is a boxplot of the percentage of fruits classified as Out of grade, for each tree for the untreated group and for the group that was treated with a composition comprising dodine. Each boxplot represents the mean value, the fat line in the box; the 25% barrier, the bottom line of the box; the 75% barrier, the top line of the box and the maximum and minimum values without the extreme values represented by the whiskers. The 2 populations are significantly different from each other, P-value smaller than 0.01.

Out of the Student's t-test on these data results that the 2 populations are different with a 99.9% probability, P-value is smaller than 0.01.

### Example 7: Determination of ED50

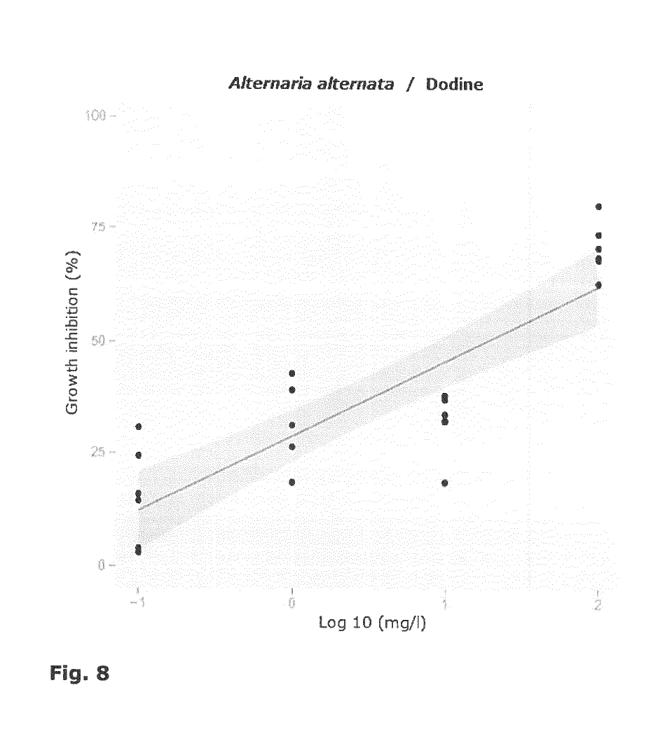

5 times 6 potato dextrose agar plates were made, only differing in the amount of dodine present in the agar plat. The plates contained 6 times 0 mg/l; 0.1 mg/l; 1 mg/l; 10 mg/l and 100 mg/l dodine. In the centre of each plate a 10 mm in diameter agar disk that was colonized with Alternaria alternata was added, and the plates were incubated in darkness at 23° C. Measurement of the mycelial growth over time was conducted and the measurement were represented as percentages compared to the growth in the plate were no dodine was added. Assuming a linear dependence of the mycelial growth and the concentration of dodine, regression determines the effective dose ED50 value, meaning the concentration of dodine that inhibits the growth of Alternaria alternata by 50% compared to the growth when no dodine was added, see FIG. 8.

FIG. 8 is a graphical presentation of the dodine concentration dependence of the growth inhibition of Alternaria alternata. In grey is the 95% confidence interval indicated.

The ED50 for Dodine against Alternaria alternata was established to range between 10 mg/l and 100 mg/l.

### Example 8: Field Trial 2014

A field trial was conducted for the control of Alternaria alternata on mandarins in Alzira, Valencia, Spain. The product used was Syllit 544 g/l suspension concentrate. Mandarins were harvested and classified using the OECD criteria (international quality standard for citrus established by the Organisation for Economic Co-operation and Development in 2010).

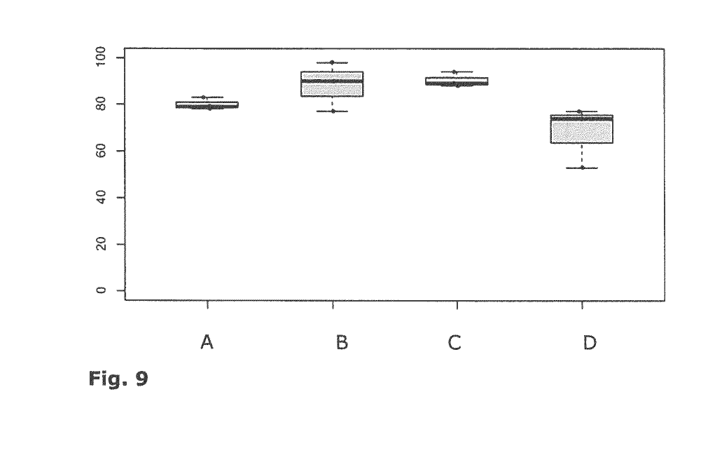

The results obtained are summarized in FIG. 9. It can be seen that the treatments with dodine clearly result in a significantly higher percentage of fruit compared to the control group receiving no treatment.

No symptoms of phytotoxicity were observed for dodine.

1. An agrochemical composition comprising an effective amount of a dodecylguanidine or salt thereof as the active ingredient for use in the treatment of Alternaria on a citrus plant.

2. The composition according to claim 1, wherein the dodecylguanidine or salt thereof comprises dodine as the only active ingredient in the composition.

3. The composition according to claim 1, wherein the composition is in the form of a suspension concentrate.

4. The composition according to claim 1, wherein the composition is in the form of a wettable powder or a water dispersible granule formulation.

5. The composition according to claim 2, wherein said dodine has a median particle diameter (d₅₀) of 7 μm to 20 μm.

6. The composition according to claim 1, wherein the composition comprises, based on the total weight of the composition:
a) 40 to 80% of a dodecylguanidine or salt thereof;
b) 0 to 10% of an anti-freeze compound;
c) 1 to 10% of a wetting agent and/or a dispersing agent;
d) 0 to 5% of an antifoaming agent;
e) 0 to 5% of a thickener;
f) 0 to 5% of a preservative; and
g) remainder water.

7. The composition according to claim 1, wherein the composition comprises an ethoxylated alkylamine and an acrylate graft polymer.

8. A method for controlling a plant disease, which comprises applying an effective amount of a composition comprising dodecylguanidine or salt thereof to a plant, wherein said plant disease is Alternaria and said plant is a citrus plant.

9. The method according to claim 8, wherein the composition comprises dodine and is applied to leaves, fruits, blossoms or a combination thereof, of said citrus plant.

10. The method according to claim 8, wherein a total dose of dodine of 300 to 3000 g dodine per hectare is applied.

11. The method according to claim 8, wherein said composition is applied within four days of an Alternaria-warning on citrus.

12. The method according to claim 9, wherein dodine is applied once every 2 or 3 weeks.

13. (canceled)

14. (canceled)

15. The method according to claim 8, wherein the composition is effective for the control of Alternaria alternata tangerine pathotype or lemon pathotype.

16. (canceled)

17. The method according to claim 8, wherein the composition is in the form of a suspension concentrate.

18. The method according to claim 8, wherein the composition is in the form of a wettable powder or a water dispersible granule formulation.

19. The method according to claim 8, wherein the composition comprises, based on the total weight of the composition:
a) 40 to 80% of a dodecylguanidine or salt thereof;
b) 0 to 10% of an anti-freeze compound;
c) 1 to 10% of a wetting agent and/or a dispersing agent;
d) 0 to 5% of an antifoaming agent;
e) 0 to 5% of a thickener;
f) 0 to 5% of a preservative; and
g) remainder water.

20. The method according to claim 8, wherein the composition comprises an ethoxylated alkylamine and an acrylate graft polymer.

21. A method for controlling Alternaria plant disease on citrus plants, which comprises the steps of:
a. applying a composition comprising an effective amount of dodine to leaves, fruits, blossoms or a combination thereof, of said citrus plant;
wherein the composition is applied at an interval of one or more of:
b. at least two days before or after rainy periods;
c. applying said composition every month; or
d. within four days of an Alternaria-warning on citrus.
